(19) United States
(12) Patent Application Publication
(10) Pub. No.: US 2021/0293732 A1
(43) Pub. Date: Sep. 23, 2021

(54) Method for Quantitatively Evaluating Ablation-Resistant Properties of Materials and Testing System Thereof

(71) Applicant: Zhejiang University, Hangzhou (CN)

(72) Inventors: Jiabin Liu, Hangzhou (CN); Hongtao Wang, Hangzhou (CN); Youtong Fang, Hangzhou (CN); Weimian Guan, Hangzhou (CN)

(21) Appl. No.: 17/205,507

(22) Filed: Mar. 18, 2021

(30) Foreign Application Priority Data
Mar. 18, 2020 (CN) 202010190902.1
Mar. 18, 2020 (CN) 202010190905.5
Mar. 18, 2020 (CN) 202010191243.3

(51) Int. Cl. G01N 25/00

(52) U.S. Cl. CPC G01N 25/00

(57) ABSTRACT

A method for quantitatively evaluating ablation-resistant properties of materials, comprising repairing a cathode sample, loading a sample into a test system, setting a minimum ablation time; conducting an arc ablation test on the sample for no less than the minimum ablation time, recording the arc ablation parameters; dividing the ablation volume by an ablation power to obtain an ablation loss rate, and taking the ablation loss rate as a quantitative evaluation index of ablation-resistant properties of electrode materials. The present invention is capable of quantitatively evaluating the arc ablation-resistant properties of electrode materials.

### CROSS REFERENCE TO RELATED APPLICATIONS

The present application claims the benefit of Chinese Patent Application Nos. 202010191243.3, 202010190905.5, 202010190902.1 filed on Mar. 18, 2020. All the above are hereby incorporated by reference in their entirety.

### FIELD OF THE INVENTION

The present invention generally relates to testing of material properties, and, more particularly to a method and test system for experimentally testing the ablation performance of materials.

### BACKGROUND

Aerospace technology is an important symbol of science and technology and a powerful guarantee for the international influence of a country, reflecting a country's comprehensive national strength. Hypersonic flight vehicles are aerospace vehicles that fly at supersonic speeds, including hypersonic missiles, hypersonic aircraft, and interstellar vehicles, etc. Due to the high-speed and long-term flight of the hypersonic vehicles in the atmosphere, the surface aerodynamic heating effect causes serious ablation of the appearance. The ablation will cause the aircraft to transition, overturn or even disintegration. Therefore, the heat protection design of hypersonic aircraft must undergo rigorous heat protection tests and assessments, to verify the reliability, effectiveness and applicability of the heat protection materials and structures of the aircrafts. At present, the assessment methods for aircraft mainly include model flight test, numerical simulation and ground wind tunnel test. Because the hypersonic numerical calculation involves multi-physics coupling, the calculation is difficult, with low precision, so it cannot be used as a basis for heat protection evaluation; the model flight test obtains limited data, with high risk of failure and high cost, thus, the ground wind tunnel test is a core way for the evaluation of hypersonic aircraft thermal protection. At present, the high-temperature wind tunnel equipment that can carry out heat protection test of hypersonic aircrafts mainly includes combustion wind tunnel, arc tunnel, shock tunnel, ballistic target, etc. For the heat protection assessment test with a Mach number of 8 or more, the upper limit of the total temperature of the flow field of the combustion wind tunnel is difficult to meet the test requirements. Shock tunnels and arc tunnels can provide high-speed and high-temperature air flow fields. However, the shock tunnel experiment time is only milliseconds, which cannot meet the needs of long-term flight test with high Mach number of hypersonic vehicles.

Relatively speaking, the arc tunnels can provide long-term continuous evaluation test conditions; therefore, it has become a necessary means for the ground heat protection evaluation of key components such as the nose, wing leading edge and engine of hypersonic aircrafts.

In the arc-heated wind tunnel test, the high voltage breaks down the air of the copper electrode in the arc heater to form a strong plasma arc discharge, which vigorously heats the high-pressure and pure air injected by rotation, to obtain a high-pressure and high-enthalpy airflow, and then accelerates through nozzle expansion to form a high-temperature jet flow, and an ablation test is performed on the specimens mounted on the nozzle outlet.

As the core of arc-heated wind tunnel, the electrodes are used in a harsh environment and need to withstand high temperature, high pressure, high current and high voltage. The extremely high heat input (˜20000 MW/m²) at the arc root results in local oxidation and melting of the electrode surface. The electrode is gradually thinned under the scouring of the high-pressure airflow, and even burned through locally, leading to air leakage and water permeability. Therefore, the ablation-resistant properties of the electrode substantially determine the test capacity of the arc heater.

Currently, there are the following main measures for reducing electrode ablation: firstly, in terms of arc control, shortening the arc root ablation time and reducing the arc root current, thereby reducing the electrode ablation; secondly, in terms of electrode materials, mainly carrying out exploration on the basic theories of the thermophysical and chemical processes related to the arc ablation, to explore the influence of material properties, material microstructure, electrode surface atmosphere and temperature on the degree of electrode material ablation. It is urgently to have a method for quantitatively evaluating the ablation-resistant properties of electrode materials.

### SUMMARY

The object of the present invention is to provide a method for quantitatively evaluating ablation-resistant properties of electrode materials and a testing system thereof through reproducing arc ablation working conditions with small-sized electrode material samples.

A method for quantitatively evaluating ablation-resistant properties of materials, comprising the following steps:

S1. Building or acquiring a test system;

S2. Preparing a cathode sample and setting the minimum ablation time;

S3. Loading the cathode sample into the test system, and conducting an arc ablation test on the cathode sample, and recording the arc ablation parameters when the ablation time of the test is greater than or equal to the minimum ablation time; recording the parameters of arc ablation, such as the operating voltage of the arc power supply, ablation time, magnetic field intensity or sample rotation speed, etc.;

S4. Removing the cathode sample after the arc ablation test, and after cooling, performing cleaning and drying of the cathode sample, then acquiring the three-dimensional contour information of the ablation area, obtaining an ablation volume, and dividing the ablation volume by an ablation power to obtain an ablation loss rate, and taking the ablation loss rate as a quantitative evaluation index of ablation-resistant properties of electrode materials.

Preferably, the three-dimensional contour information of the ablation area is acquired by a surface profiler in step S4.

Any of the aforesaid test system can be used in the step S1.

Preferably, the arc contact surface of the cathode sample is smooth and free of local protrusions, and the surface roughness Ra of the arc contact surface is less than or equal to 0.8 μm in the step S2, meeting the surface conditions for uniform discharge and arc ignition.

Preferably, the sample arc contact surface is subjected to grinding, polishing and drying in the step S2.

Preferably, the testing on the thermal conductivity, electrical conductivity and hardness of the sample is performed at a room temperature after processing the arc contact surface of the cathode sample in step S2. Because the electrode material needs to have the ablation resistance of the arc contact surface and the high electrical and thermal conductivity of the base, the testing of the electrical and thermal conductivity of material can be used to comprehensively evaluate the suitability of the material as an electrode, or select the material when the ablation resistance is similar. The hardness value is usually used for the evaluation of the mechanical properties of material as the electrode needs to have a certain structural strength in use to withstand the squeezing action of the high-pressure air flow on the inner wall and the high-pressure water flow on the back.

Preferably, the arc contact surface of the cathode sample is maintained horizontally in the vertical direction when loading sample in step S3, and the anode electrode is moved synchronously to align the ablation starting position of the cathode sample.

Preferably, the cathode sample is ultrasonically cleaned in the step S2, and the ablated cathode sample is ultrasonically cleaned in step S4. Through ultrasonic cleaning, the black contaminants adhering to the ablated area are removed, improving the degree of surface light reflection.

In one aspect, the present invention provides a test system for evaluating the arc ablation resistance of materials when testing the arc ablation resistance of materials, comprising an anode, a sample mounting part for loading the cathode sample, a cooling system for cooling the cathode sample; an arc is generated between the cathode and the anode, the anode and the cathode are provided with ports connected with the arcing power supply respectively; the cathode sample is detachably assembled with the sample mounting part, when the cathode sample is loaded in the sample mounting part, the cathode sample is in contact with the coolant of the cooling system; a driving device is arranged between the cathode and the anode, and the driving device makes the arc and the cathode sample to have relative displacement.

Preferably, the relative displacement between the arc and the cathode sample is a rotational displacement; or, the relative displacement between the arc and the cathode sample is a plane displacement.

Preferably, the cooling medium chamber of the cooling system is located in the sample loading area. A metal sealing ring is arranged between the cathode sample and the cooling medium chamber.

The metal sealing ring can withstand high temperature ablation without failure, and maintain good sealing of the cooling system.

Preferably, the insulating ring presses the cathode sample against the sample mounting part.

During the test, a cathode sample is made and loaded on the sample mounting part, the anode and cathode are energized, the anode generates an arc to the cathode, and the arc ablates the cathode. At the same time, the cooling system cools the cathode and controls the arc and cooling system, to simulate real arc ablation conditions. After the arc ablation experiment is completed, the cathode sample is removed and the testing of materials after ablation is performed to determine the ablation-resistant properties of the cathode sample.

In one situation, the sample is a flat sheet sample, and the driving device makes the arc and the cathode sample to have relative displacement.

A Solution Using a Three-Axis Mobile Platform as the Driving Device

As a preferred embodiment, the driving device is a three-axis mobile platform. The three-axis mobile platform comprises an X-direction moving axis, a Y-direction moving axis and a Z-direction moving axis. The anode is fixed on the Z-direction moving axis; the sample mounting part comprises a substrate and a cooling system that is arranged in the substrate. The cooling system comprises a coolant water inlet tube, a coolant water outlet tube and a cooling groove. The cathode substrate is provided with a sample pressing plate; a metal sealing ring is provided outside the cooling groove; and the cathode sample is provided with a seal groove matching the metal sealing ring.

When conducting an arc ablation test on a sample, the sample is used as a cathode. Initially, a groove matching the stainless steel sealing ring is machined on the surface of the sample, and the sample is pressed against the sample mounting part with a pressing block. The groove on the surface of the sample and the metal sealing ring are in tight fit, the coolant is confined between the cooling groove and the sample, and the stainless steel sealing ring prevents the coolant from leaking.

Preferably, the metal sealing ring is a stainless steel sealing ring. Preferably, the stainless steel sealing ring is made of 316L stainless steel of solid solution state.

As a preferred embodiment, a power terminal interface is provided on the substrate, and the power terminal interface is electrically connected to the cooling groove, then the cooling medium is used as a conductor to connect the sample. The power terminal interface is connected to the power cathode, such that the sample becomes the cathode in the arc ablation system, and the anode is connected to the power anode, thereby generating an electric arc between the anode and the sample.

As a preferred embodiment, a sample groove for accommodating samples is provided on the substrate, the cooling groove is located in the area of the sample groove, a sample holding surface is arranged between the cooling groove and the inner wall of the sample groove, and the metal sealing ring is arranged on the sample holding surface. In other words, a groove for accommodating samples is provided on the substrate, to become a sample groove. In the sample groove, another groove is dug as a cooling groove for accommodating the coolant. A frame appears between the cooling groove and the sample groove, and the frame serves as the sample holding surface for holding samples. The sample and the sample groove are in clearance fit, and the sample completely covers the metal sealing ring.

Preferably, the coolant water inlet tube has a water inlet channel communicating with the cooling groove, and there are at least one water inlet channels. Preferably, the water inlet channel is a vertically upward through hole, the bottom of the water inlet channel is in communication with the coolant water inlet tube, and the top of the water inlet channel is in communication with the cooling groove. The water in the coolant water inlet tube escapes from bottom to top and reaches the cooling groove. The cooling water flows through the water inlet channel and is forced to change the flow direction, and flow through the back of the sample, to ensure a good cooling effect on the sample.

Preferably, the coolant water outlet tube is located under the cooling groove, and the cooling groove is in communication with the coolant water outlet tube via the water outlet channel. There is a circular arc transition or an inclined transition between the water outlet channel and the coolant water outlet tube.

Preferably, there is a sample loading groove on the substrate, a sample fixing part is arranged in the sample loading groove. A pair of sample fixing parts is respectively located at the two ends of the sample loading groove; the cooling groove is located between the sample fixing parts; the metal sealing ring is located between the cooling groove and the sample fixing part. The back of the sample is provided with a seal groove that is in sealing fit with the metal sealing ring. After the sample is prepared, it is put into the sample loading groove, and both ends of the sample are fixed with the sample fixing part. At the same time, the seal groove of the sample fits tightly with the metal sealing ring. The back of the sample is in contact with the cooling groove; the metal sealing ring confines the cooling liquid in the cooling groove to avoid leakage or seepage of the cooling liquid.

Preferably, there are screw holes on the sample fixing member, each sample fixing part corresponds to a sample pressing plate, and the sample pressing plate is correspondingly provided with matching screw holes. The width of the sample groove is 1 to 2 mm larger than the sample, and the length of the sample groove is 1 to 2 mm larger than the sample. In other words, when preparing the sample, the sample width is 1 to 2 mm smaller than that of the sample groove, and the sample length is 1 to 2 mm smaller than that of the sample groove.

Further, a plurality of sample loading grooves are provided on the substrate. An ablation performance test can be performed on multiple samples.

The sample mounting part has a sample loading area, the loaded cathode sample is a sheet sample, and the anode is centered with the sample loading area. Sheet samples are relatively easy to produce, with relatively simple production process and few materials. Compared with the cathode of an arc-heated wind tunnel, the present invention greatly reduces the requirements on the amount and size of the cathode sample.

For the Flat Sheet Sample, Arc is Driven to Rotate Around the Cathode Sample by the Electromagnetic Field

If the discharge continues at a certain part, electrodes will melt, ablate, and fail quickly due to the extremely high temperature of arcs. Therefore, when screening the arc ablation resistant materials, in order to reproduce the arc ablation situation of the arc wind tunnel more realistically, a variety of technical solutions are proposed to make the arc and the cathode sample to have a relative rotational movement for the test system in the present invention.

The cathode sample is fixed, and the arc rotates around the center of the cathode sample.

Preferably, the test system is provided with a base, and the protective cover encloses the sample mounting part between the protective cover and the base.

Preferably, an atmosphere inlet is provided on the protective cover, and the atmosphere inlet is connected to the high-pressure air supply system through a pipe. The atmosphere inlet enables the protective atmosphere to enter the space where an arc ablation occurs. When the atmosphere is introduced, the pipe of the atmosphere inlet is connected to the gas source. If nitrogen is introduced, it is connected to the nitrogen source. If air is introduced, it is connected to the air source.

As a preferred embodiment, an electromagnetic coil is provided outside the protective cover, and the magnetic field direction of the electromagnetic coil is parallel to the direction where the anode points to the cathode, the electromagnetic coil has a port connected to the coil power supply; an insulating ring is provided outside the sample loading area, and the insulating ring is centered with the sample loading area.

When the magnetic field direction of the electromagnetic coil is parallel to the direction where the anode points to the cathode, the movement direction of the charged particles in the arc column is the same as the direction of the magnetic field, and the electric field force generated is zero.

However, the concentration of charged particles in the section of the arc column gradually decreases from the center to the periphery, and the difference in the concentration of the charged particles causes the diffusion of the charged particles from the center to the periphery. Taking the cross section of the arc column as the XOY plane, the diffusion motion of the charged particles caused by the concentration difference has the radial motion components Vx and Vy, and the motion components Vx and Vy are perpendicular to the magnetic field. At this time, due to the diffusion of the charged particles in the x direction and y direction, the Lorentz force is generated under the action of the magnetic field. The Lorentz force acts on the electrons (or ions) that are being diffused, making them to produce circular motions, with a speed of Vz. The charged particles moving in a circle along the radius r generate a centripetal force Fx under the action of a magnetic field. The charged particles have motion components in both directions Vx and Vy at the same time, so the actual motion route of the charged particles is a spiral line with a radius of r. Under the action of an external magnetic field, the movement of the charged particles in the arc from the anode to the cathode becomes a spiral movement along the direction of magnetic line of force. The greater the intensity of the applied magnetic field, the smaller the radius of the spiral. The charged particles move in a spiral motion under the action of the Lorentz force, and continuously collide with neutral particles during the motion, thereby driving the arc to rotate. As the intensity of the magnetic field increases, the radius of rotation decreases and the arc constricts. The intensity of the magnetic field decreases, the radius of rotation increases, and the arc diffuses. Therefore, by externally adding an electromagnetic coil, the intensity of the electromagnetic field is changed to achieve the purpose of rotating the arc relative to the sheet sample.

The insulating part is outside, the cathode sample is inside, and the insulating part limits the arc inside.

Preferably, the sample mounting part comprises a base, the base is provided with a cooling medium chamber, the cooling medium chamber is respectively in communication with the liquid inlet tube and the liquid outlet tube, and the liquid inlet tube and the liquid outlet tube are connected with the circulating cooling system; when the cathode sample is loaded on the sample mounting part, the cathode sample closes the cooling medium chamber. The description of “sample closes the cooling medium chamber” means that the cooling medium chamber has no openings other than the liquid inlet tube and the liquid outlet tube.

The cooling medium is in contact with the cathode sample, to cool and dissipate the cathode sample, preventing the cathode sample from being broken down when it touches the arc. The working condition of the cathode materials being ablated for a long time is simulated.

Preferably, the cooling medium chamber is an open concave chamber at the top of the base, when the sample is loaded on the sample mounting part, the cathode sample closes the cooling medium chamber.

Preferably, the liquid inlet tube and the liquid outlet tube are arranged on the side of the base.

Preferably, the liquid inlet tube is lower than the liquid outlet tube.

Preferably, the circulating cooling system comprises a liquid storage tank and a pump. The liquid storage tank is respectively connected to a liquid inlet tube and a liquid outlet tube through a pipe, and the pump is arranged on the pipe.

Preferably, the cathode sample is circular, and the cooling medium chamber is a circular chamber.

Preferably, the cross-section of the protective cover is circular, the protective cover is provided with an atmosphere inlet, and gas inflows from the atmosphere inlet tangentially. There is at least one group of atmosphere inlets and when there are multiple groups of atmosphere inlets, the multiple groups of atmosphere inlets are uniformly arranged along the circumferential direction of the contour. The atmosphere enters the area where the arc occurs in a tangential direction, which is beneficial to provide a rotary boost for the arc.

For the Flat Sheet Sample, a Driving Device with the Autorotation of Sample Mounting Part of the Cathode Sample

The sample mounting part carries the cathode sample to rotate around the center, and the arc is fixed or moves in a radial direction.

As a preferred embodiment, sample mounting part comprises a base, the base has a cooling medium chamber and a liquid inlet ring, the cooling medium chamber is located in the sample loading area, when the cathode sample is loaded on the sample mounting part, the cathode sample is centered with the sample loading area; the cooling medium chamber is inside and the liquid inlet ring is outside, and the liquid inlet ring is in communication with the cooling medium chamber and is in rotatably sealing fit; the liquid inlet ring is fixed and connected with the liquid inlet tube, the center of the cooling medium chamber is provided with a liquid outlet channel; the test system has a rotary drive assembly connection, and the rotary drive assembly includes a driven wheel fixed to the base and a driving wheel connected with the motor, and the driven wheel is centered with the base.

The rotary drive assembly drives the cathode sample to rotate around the center, the base follows the rotary drive assembly to rotate, and the sample follows the base to rotate; the liquid inlet ring remains fixed and is connected to the input tube of the cooling medium. The liquid outlet channel is arranged in the center of the cooling medium chamber, and it only needs to connect a rotatable liquid seal joint on the liquid outlet channel. In this way, the circulation of the cooling medium in the cooling medium chamber is realized through the liquid inlet ring and the liquid outlet channel, so that the cathode sample can be continuously cooled.

Preferably, the base is cylindrical, the side wall of the cooling medium chamber is provided with a plurality of through holes, the liquid inlet ring is in the form of a circular ring, and the liquid inlet ring covers all the through holes, and a sealing ring is arranged between the liquid inlet ring and the base. The sealing ring restricts the cooling medium in the liquid inlet ring and the cooling medium chamber, and the liquid enters from the liquid inlet ring to the cooling medium chamber in the direction of the entire ring circumference.

Through the setting of the liquid inlet ring, the input tube of the cooling medium is prevented from rotating with the base, avoiding the problem of pipe winding.

Preferably, the base and the driven wheel are coaxially fixed, the base is inside, and the driven wheel is outside. The base and the driven wheel can be fixed by tenon and mortise, or by key connection, etc.

Preferably, the base is an integrated cylinder, and the top of the cylinder is open and is in sealing fit with the cathode sample, the bottom of the cylinder is provided with a liquid outlet channel. In this case, the liquid outlet channel is connected with the rotatable seal joint to avoid the problem of output tube rotation.

Alternatively, the base comprises a cathode base top cover and a fixed base, the middle of the cathode base top cover is provided with a through hole, the cathode base top cover and the fixed base are in rotatably sealing fit, the cathode base top cover and the fixed base are combined to form a cooling medium chamber. Preferably, the cathode base top cover and the fixed base are in rotatable fit, and a sealing ring is arranged between the cathode base top cover and the fixed base. By this way, the cathode base top cover and the fixed base are in rotatably sealing fit. In this case, the fixed base is connected with the fixed output tube.

Preferably, the cathode base top cover has a first connecting portion connected with the cathode sample and a second connecting portion connected with the driven wheel; the first connecting portion has a distance from the driven wheel; Preferably, the first connecting portion and the second connecting portion are in a two-segment form, the second connecting portion extends a ring of flange outwards along the first connecting portion, and the second connecting portion serves as a flange connected to the driven wheel, by this way, a stable connection between the cathode base top cover and the driven wheel is realized.

Preferably, the gas inflows from the atmosphere inlet of the protective cover axially and/or tangentially. The gas inflows axially, reducing the influence of the airflow on the arc.

When screening cathode materials, the stagnation ablation test is carried out. The parameters such as stagnant point ablation time, power, and material loss after ablation are used to evaluate the ablation-resistant properties of materials. Therefore, the stagnation ablation test is also option in the experiments.

Any of the foregoing test system can be used for stagnant point ablation. For a solution with the electromagnetic coil, it can be realized without supplying power to the electromagnetic coil. For a solution with a rotary drive assembly, it can be achieved by stopping the rotary drive assembly.

After setting up the test system, the cathode sample is prepared and loaded to the sample mounting part for ablation experiments. After the ablation experiment, the cathode sample is taken out for quantitative evaluation of ablation-resistant properties.

In another situation, the cathode is a tubular sample, and the arc and the flat sheet cathode sample are relatively displaced in the test system and driving device.

As a preferred embodiment, the cathode sample is a hollow tube with openings at both ends of the cathode, both ends of the cathode sample are connected to a high-pressure rotary joint in a sealed manner respectively, one high-pressure rotary joint is connected to the coolant input tube and the other high-pressure rotary joint is connected to the coolant output tube, the coolant enters the hollow tube from the input tube and flows out from the output tube, a cooling mechanism for cooling the coolant is arranged between the input tube and the output tube, or a liquid storage device for providing coolant is arranged between the input tube and the output tube; the cathode sample is connected with the driving device, and the anode is aligned with the outer surface of the cathode sample. The arc is formed between the anode and the cathode, the cathode sample rotates around the central axis, and the root of the arc is displaced along the outer surface of the cathode.

Preferably, the anode is fixed, or the anode is connected to a translation drive mechanism that provides translation along the axial direction of the hollow tube. When the anode is translated along the axial direction of the hollow tube, the arc root forms a spiral line along the outer surface of the cathode. When the anode is fixed, the arc root forms a circle along the outer surface of the cathode.

Preferably, the high-pressure rotary joint comprises a first connecting portion connected to the cathode sample, a second connecting portion connected to the tube, the first connecting portion and the second connecting portion are rotatably sealed and connected; the first connecting portion is connected with the driving device, and the second connecting portion is fixed on a bracket; and cathode sample is erected on the bracket by two high-voltage rotary joints.

The driving device comprises a motor and a transmission mechanism. The transmission mechanism is a gear mechanism, or a turbine screw, or a chain transmission mechanism, etc.

The present invention has the following advantages.
1. The cathode sample is prepared into a sheet sample, to build an arc and cool the cathode sample while performing arc ablation on the cathode sample, and simulate the ablation condition of the arc-heated wind tunnel. Relative to the ground arc-heated wind tunnel, it can not only simulate the actual working conditions, but also consume fewer materials; in addition, the structure is simple and the cost is low, which is convenient for material screening.
2. The arc is rotated by setting the electromagnetic coil, and when the cathode sample is fixed, the arc can move and ablate the cathode samples.
3. By setting the rotary drive assembly, the sample will rotate automatically, and when the arc is fixed, the arc can move and ablate the cathode sample.
4. It is proposed that the ablation rate is the evaluation index of material ablation-resistant properties, and the specific steps to obtain the ablation rate are given, which can quantitatively evaluate the ablation-resistant properties of cathode materials.

### BRIEF DESCRIPTION OF THE DRAWINGS

FIG. 1 is a schematic diagram of Example 1.

FIG. 2 is a schematic diagram of a protective cover.

FIG. 3 is the composition diagram of a magnetic rotating arc generator.

FIG. 4 is a schematic diagram of arc root rotation.

FIG. 5 is a schematic diagram of atmosphere gas inflow tangentially from the protective cover.

FIG. 6 is the composition diagram of actively rotating arc generator for the cathode sample.

FIG. 7 is an exploded view of a main body of an arc generator.

FIG. 8 is the top view of an arc generator.

FIG. 9 is a schematic diagram of a top cover on a cathode holder.

FIG. 10 is a schematic diagram of the cooling water flow on the back of the electrode.

FIG. 11 is a design drawing of the rotating trajectory of the arc root revolving the axis on the sample surface.

FIG. 12 is the diagram showing failure of pure copper samples after ablation.

FIG. 13 is a three-dimensional outline drawing of pure copper after ablation (burning arc 720 s).

FIG. 14 is a three-dimensional contour drawing of a copper-chromium alloy Cu50Cr50 electrode after ablation (fire arc 720 s).

FIG. 15 is a three-dimensional contour drawing of pure copper after ablation (120 s arc).

FIG. 16 is a schematic diagram of the ablation resistance test system for tubular samples.

FIG. 17 is a schematic diagram of the structural composition of the ablation resistance test system for tubular samples.

### DETAILED DESCRIPTION

The specific structure scheme of the test system of the present invention will be described in detail in conjunction with the appended drawings.

### Example 1

This example describes a test system for stagnation point ablation.

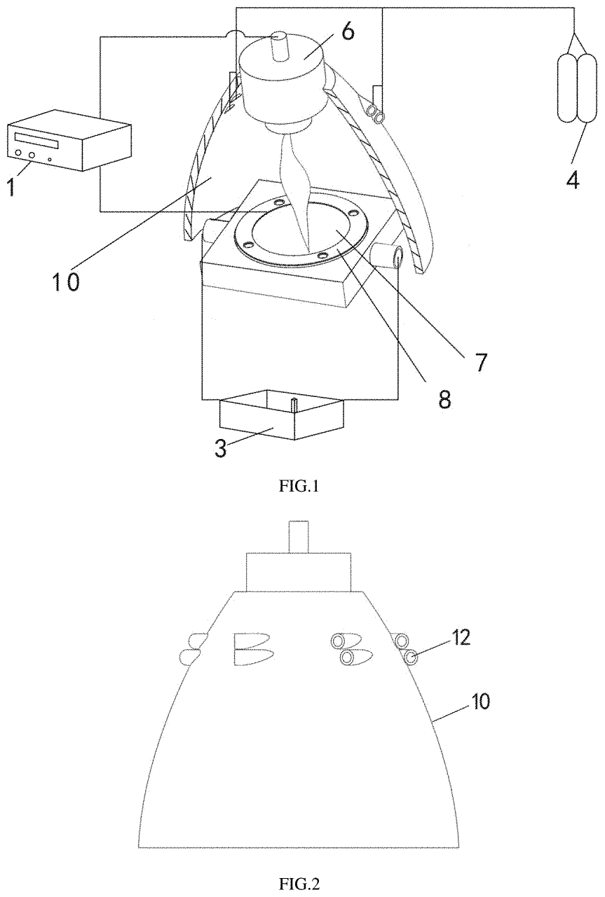

As shown in FIG. 1, the test system used to screen the ablation performance of arc ablation resistant materials comprises an anode 6, a sample mounting part for loading the cathode sample, a cooling system 3 for cooling the cathode sample, and a protective cover 10; an arc is generated between the cathode and the anode 6, and is located in the protective cover 10; an arc is generated between the cathode and the anode 6, and is located in the protective cover 10; the direction of the magnetic field generated by the electromagnetic coil 9 is parallel to the direction from the anode 6 to the cathode; the anode 6 and the cathode are provided with ports connected with the arcing power supply respectively; the cathode sample 7 is detachably assembled with the sample mounting part.

A cathode sample 7 is made by a cathode material and loaded on the sample mounting part, and the protective cover 10 is covered, the anode 6 and cathode are energized, the anode 6 generates an arc to the cathode, and the arc ablates the cathode. At the same time, the cooling system 3 cools the cathode and controls the arc and cooling system 3, to simulate real arc ablation conditions. After the arc ablation experiment is completed, the cathode sample 7 is removed and the testing of materials after ablation is performed to determine the ablation-resistant properties of the cathode sample 7.

The sample mounting part has a sample loading area, the loaded cathode sample 7 is a sheet sample, and the anode 6 is centered with the sample loading area. Sheet samples are relatively easy to produce, with relatively simple production process and few materials. Compared with the cathode of an arc-heated wind tunnel, the present invention greatly reduces the requirements on the amount and size of the cathode sample 7.

The cooling medium chamber of the cooling system 3 is located in the sample loading area, and a metal sealing ring 5 is provided between the cathode sample 7 and the cooling medium chamber.

The metal sealing ring 5 can withstand high temperature ablation without failure, and maintain the good sealing performance of the cooling system 3. The insulating ring 8 presses the cathode sample 7 to the sample mounting part.

### Example 2

This example describes a material ablation-resistant properties test system that can introduce into a protective atmosphere as needed.

The difference between this example and Example 1 is as follows: as shown in FIG. 2, an atmosphere inlet 12 is provided on the protective cover 10, and the atmosphere inlet 12 is connected to the high-pressure gas supply system through a pipe. The atmosphere inlet 12 enables the protective atmosphere to enter the space where an arc ablation occurs. When the atmosphere is introduced, the pipe of the atmosphere inlet 12 is connected to the gas source. If nitrogen is introduced, it is connected to the nitrogen source 4. If air is introduced, it is connected to the air source 4.

The test system is provided with a base 11, and the protective cover 10 encloses the sample mounting part between the protective cover 10 and the base 11. Of course, it does not need to be sealed.

The rest of the structure is the same as Example 1.

### Example 3

This example shows an ablation-resistant property test system in which the arc rotates relative to the cathode.

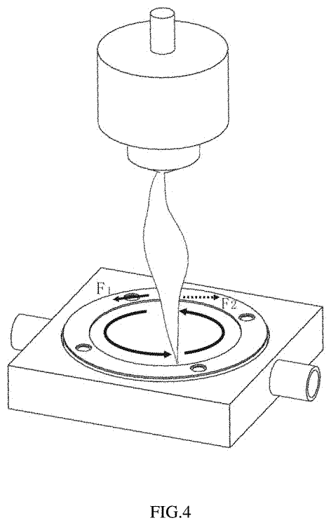

The difference between this example and Example 1 or 2 is as follows: As shown in FIG. 4, the cathode sample 7 is fixed, and the arc rotates around the center of the cathode sample 7.

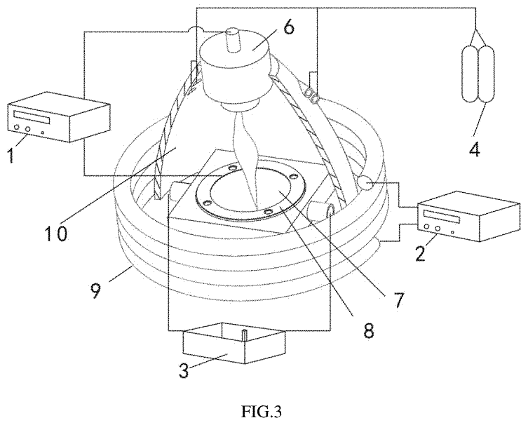

As shown in FIG. 3, the test system has an electromagnetic coil 9. The magnetic field direction of the electromagnetic coil 9 is parallel to the direction where the anode 6 points to the cathode. The electromagnetic coil 9 has a port connected to the coil power supply 2; an insulating ring 8 is provided outside the sample loading area, the insulating ring 8 is centered with the sample loading area. The electromagnetic coil 9 is arranged outside the protective cover 10. The insulating ring 8 is outside, the cathode sample 7 is inside, and the insulating ring 8 limits the arc inside.

As shown in FIG. 4, the sample mounting part comprises a base, the base is provided with a cooling medium chamber, the cooling medium chamber is respectively in communication with the liquid inlet tube and the liquid outlet tube, and the liquid inlet tube and the liquid outlet tube are connected with the circulating cooling system 3; when the cathode sample 7 is loaded on the sample mounting part, the cathode sample 7 closes the cooling medium chamber. The description of “cathode sample 7 closes the cooling medium chamber” means that the cooling medium chamber has no openings other than the liquid inlet tube and the liquid outlet tube.

The cooling medium is in contact with the cathode sample 7, to cool and dissipate the cathode sample 7, preventing the cathode sample 7 from being broken down when it touches the arc. The working condition of the cathode materials being ablated for a long time is simulated.

The cooling medium chamber is an open concave chamber at the top of the base, when the sample is loaded on the sample mounting part, the cathode sample 7 closes the opening of the cooling medium chamber at the top.

As shown in FIG. 3, the liquid inlet tube and the liquid outlet tube are arranged on the side of the base; the liquid inlet tube is lower than the liquid outlet tube. The circulating cooling system 3 comprises a liquid storage tank and a pump. The liquid storage tank is respectively connected to a liquid inlet tube and a liquid outlet tube through a pipe, and the pump is arranged on the pipe. The cathode sample 7 is circular, and the cooling medium chamber is a circular chamber. The cross-section of the protective cover 10 is circular, and gas inflows from the atmosphere inlet 12 tangentially, as shown in FIG. 5. As shown in FIG. 2, when there are at least one group of atmosphere inlets 12 and there are multiple groups of atmosphere inlets 12, the multiple groups of atmosphere inlets 12 are uniformly arranged along the circumferential direction of the contour. The atmosphere enters the area where the arc occurs in a tangential direction, which is beneficial to provide a rotary boost for the arc.

The rest of the structure is the same Example 1 or 2.

### Example 4

This example shows that the sample rotates while the arc is rotating.

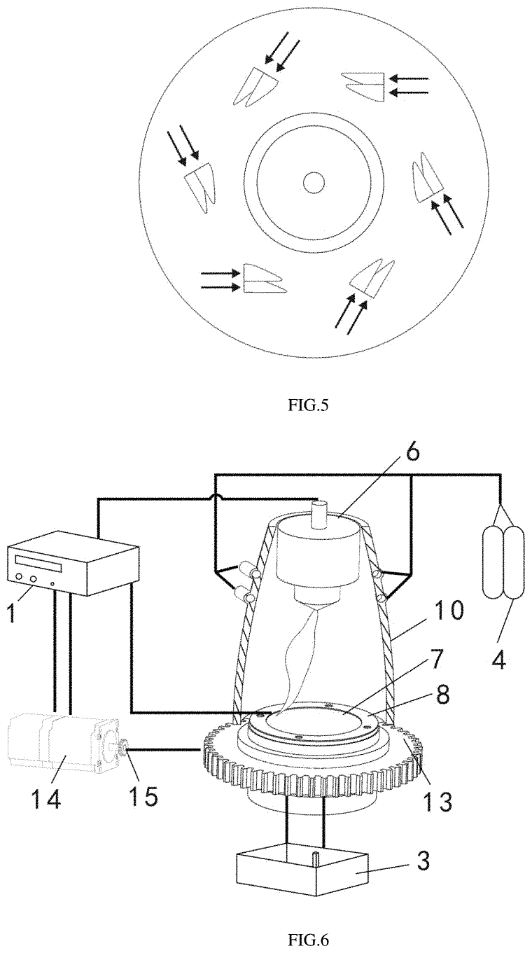

The difference between this example and Example 1 or 2 is as follows: as shown in FIG. 6, this example adds a sample mounting part that drives the cathode sample 7 to rotate around the center, and the arc is fixed or moves in a radial direction.

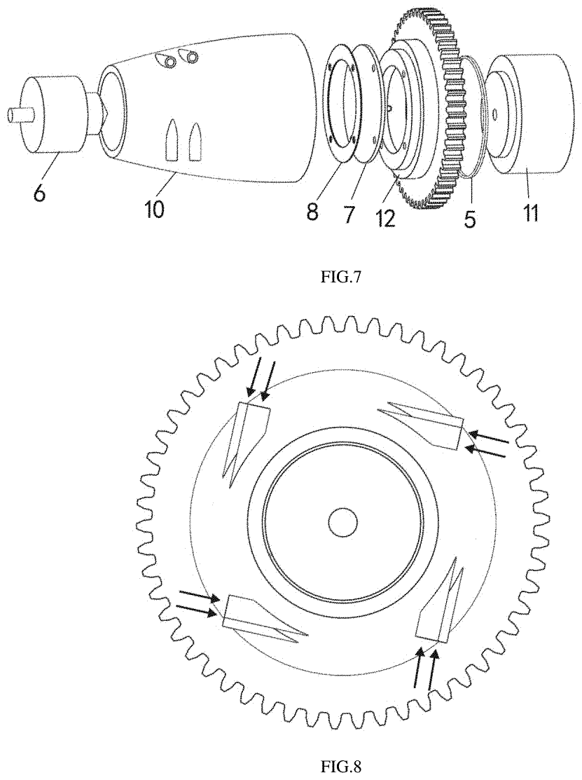

As shown in FIG. 6 and FIG. 7, the sample mounting part comprises a base, the base has a cooling medium chamber and a liquid inlet ring, the cooling medium chamber is located in the sample loading area, when the cathode sample 7 is loaded on the sample mounting part, the cathode sample 7 is centered with the sample loading area; the cooling medium chamber is inside and the liquid inlet ring is outside, and the liquid inlet ring is in communication with the cooling medium chamber and is in rotatably sealing fit; the liquid inlet ring is fixed and connected with the liquid inlet tube, the center of the cooling medium chamber is provided with a liquid outlet channel; the test system has a rotary drive assembly connection, and the rotary drive assembly includes a driven wheel 13 fixed to the base and a driving wheel 15 connected with the motor 14, and the driven wheel 13 is centered with the base.

As shown in FIG. 6, the rotary drive assembly drives the cathode sample 7 to rotate around the center, the base follows the rotary drive assembly to rotate, and the sample follows the base to rotate; the liquid inlet ring remains fixed and is connected to the input tube 19 of the cooling medium. The liquid outlet channel is arranged in the center of the cooling medium chamber, and it only needs to connect a rotatable liquid seal joint on the liquid outlet channel. In this way, the circulation of the cooling medium in the cooling medium chamber is realized through the liquid inlet ring and the liquid outlet channel, so that the cathode sample 7 can be continuously cooled.

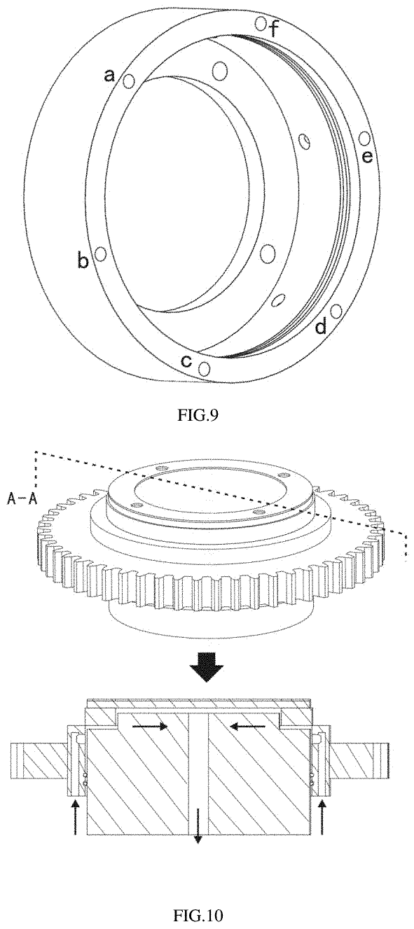

As shown in FIGS. 9 and 10, the base is cylindrical, the side wall of the cooling medium chamber is provided with a plurality of through holes, the liquid inlet ring is in the form of a circular ring, and the liquid inlet ring covers all the through holes, and a sealing ring is arranged between the liquid inlet ring and the base 5. The sealing ring 5 restricts the cooling medium in the liquid inlet ring and the cooling medium chamber, and the liquid enters from the liquid inlet ring to the cooling medium chamber in the direction of the entire ring circumference.

Through the setting of the liquid inlet ring, the input tube 19 of the cooling medium is prevented from rotating with the base, avoiding the problem of pipe winding.

Preferably, the base and the driven wheel 13 are coaxially fixed, the base is inside, and the driven wheel 13 is outside. The base and the driven wheel 13 can be fixed by tenon and mortise, or by key connection, etc.

The base is an integrated cylinder, and the top of the cylinder is open and is in sealing fit with the cathode sample 7, the bottom of the cylinder is provided with a liquid outlet channel. In this case, the liquid outlet channel is connected with the rotatable seal joint to avoid the problem of rotation of the output tube 18.

Gas inflows from the atmosphere inlet 12 of the protective cover 10 axially, and/or as shown in FIG. 8, gas inflows from the atmosphere inlet 12 tangentially, as shown in FIG. 5. The gas inflows along the axial direction, reducing the influence of the airflow on the arc.

The rest of the structure is the same Example 1 or 2.

### Example 5

The difference between this example and Example 4 is as follows: as shown in FIG. 7, the base comprises a cathode base top cover 12 and a base 11, the middle of the cathode base top cover 12 is a through hole, and the cathode base top cover 12 and the base 11 are in rotatably sealing fit, and the cathode base top cover 12 and the base 11 are combined to form a cooling medium chamber.

The cathode base top cover 12 and the base are in rotatable fit, and a sealing ring 5 is arranged between the cathode base top cover 12 and the base 11. In this way, the cathode base top cover 12 and the base 11 are in rotatably sealing fit. In this case, the base 11 can be connected to the fixed output tube 18.

The cathode base top cover 12 has a first connecting portion connected with the cathode sample 7 and a second connecting portion connected with the driven wheel 13; the first connecting portion has a distance from the driven wheel 13; the first connecting portion and the second connecting portion are in a two-segment form, the second connecting portion extends a ring of flange outwards along the first connecting portion, and the second connecting portion serves as a flange connected to the driven wheel 13, by this way, a stable connection between the cathode base top cover 12 and the driven wheel 13 is realized.

The rest of the structure is the same Example 4.

### Example 6

A method for quantitatively evaluating ablation-resistant properties of materials, comprising the following steps:

S1. Building or acquiring a test system, and the test system adopts stagnation point ablation, and the atmosphere of the protective cover 10 is air.

S2. Preparing cathode sample 7; preparing a sheet sample with a single sample size of 68*18*3 mm3 by wire cutting. The electrode material is pure copper and the density is 8.9 g/cm³, of which, the arc contact surface (top surface) is ground and polished with a 500-2000-mesh sandpaper, to ensure that the surface roughness Ra is ≤0.8 m, the thermal conductivity of the sample is 395 W m⁻¹ K⁻¹, the conductivity is 99% IACS, and the hardness is 80 HV.

S3. Loading the cathode sample 7 on the test system, and conducting an arc ablation test on the cathode sample 7, and recording the arc ablation parameters: the arc current is 15 A, the arcing time is 720 s, and the coolant flow rate on the back of the electrode is 0.8 L/min, the arc length is about 3 to 4 mm, the diameter of the arc spot is about 0.5 to 0.8 mm under the filter condition, and the spontaneous movement rate of the arc spot on the surface of the cathode sample 7 is about 10⁻² m/s; the arc performs stagnation point ablation on the cathode sample 7;

S4. Removing the cathode sample 7 after the arc ablation test, and after cooling, performing cleaning and drying of the cathode sample 7, then acquiring the three-dimensional contour information of the ablation area, obtaining an ablation volume of 672±2.57 mm³, and dividing the ablation volume by an ablation power to obtain an ablation loss rate, which is (62.2±0.238)×10⁻³ mm³/C, and taking the ablation loss rate as a quantitative evaluation index of ablation-resistant properties of electrode materials.

As shown in FIG. 12, the sheet-shaped pure copper sample used for electrode ablation has a processing size of 68*18*3 mm³ and a density of 8.9 g/cm³ and the arc contact surface (top surface) is ground and polished with 500-2000 mesh sandpaper to ensure that the surface roughness Ra is ≤0.8 μm. After ablation, under stagnation point ablation, a circular ablation hole with a diameter of about 5 mm is left on the surface of the electrode, with a clear boundary between the edge and the unablated area.

As shown in the three-dimensional contour map in FIG. 13, the corresponding sample is the pure copper sample after the stagnation point ablation in FIG. 12. Through this figure, the line contour information in any XZ or YZ direction and the ablation volume relative to a plane parallel to the XOY can be obtained. According to the figure, the calculated ablation volume is 672±2.57 mm³, and the converted ablation rate is (62.2±0.238)×10⁻³ mm³/C. It can be observed from the figure that the ablated area is obviously concave, and there is an extrusion peak about 50-100 m high at the boundary of the unablated area, which is caused by the accelerated solidification of the molten pool of pure copper with high thermal conductivity.

### Example 7

The difference between this example and Example 6 is that the cathode sample 7 is a copper-chromium alloy electrode sample (Cu50Cr50), the size of the cathode sample 7 is also 68*18*3 mm³, and the thermal conductivity of the sample is 236 W m⁻¹ K⁻¹. The conductivity is 60% IACS and the hardness is 170 HV, and the rest of the structure and parameters are consistent with those in Example 6.

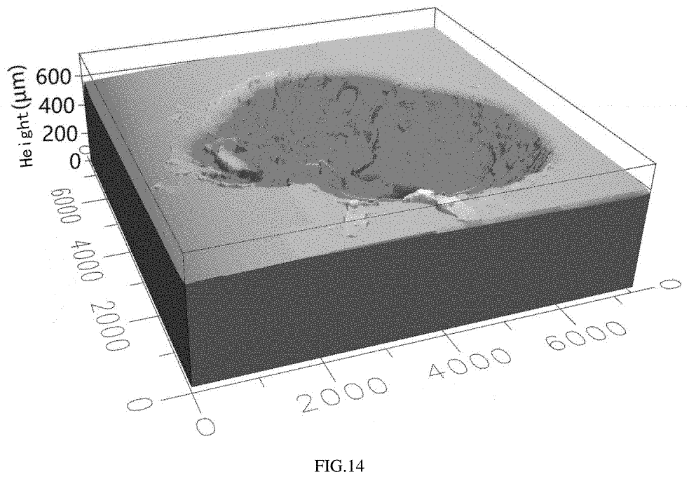

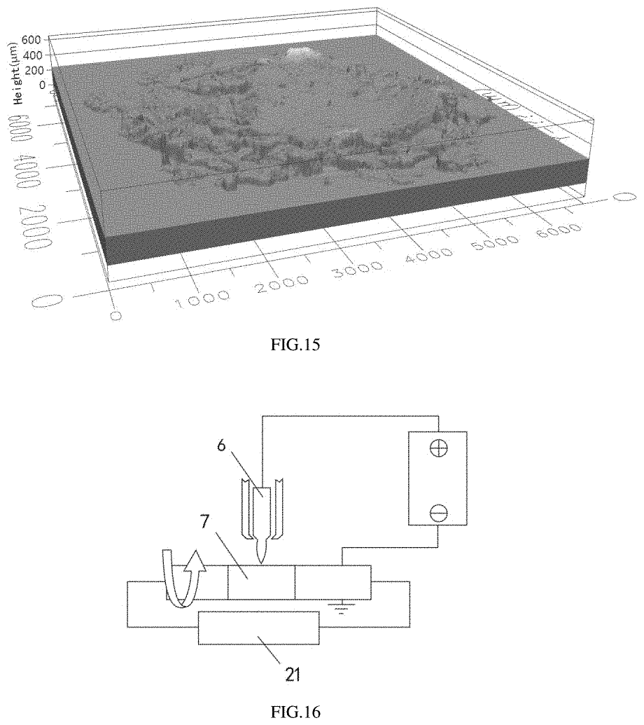

FIG. 14 shows the ablation three-dimensional profile of the copper-chromium alloy electrode sample (Cu50Cr50). The copper-chromium alloy electrode sample is ablated at a stagnation point for 720 s under a 15 A arc, the arc length is about 2 to 3 mm, the arc spot diameter is about 0.6 to 0.9 mm under the filter condition, and the spontaneous movement rate of the arc spot on the surface of the cathode sample 7 is about (0.4 to 0.6)×10⁻² m/s. The calculated ablation volume is 526±6.21 mm³, and the converted ablation rate is (48.7±0.575)×10⁻³ mm³/C. After ablation, compared with FIG. 12, the side wall of the ablated area of the sample is smoother, and the local heights are staggered slightly, and the height of the extrusion peak at the boundary between the ablated and non-ablated areas is reduced.

### Example 8

The difference between this example and Example 6 is that the cathode sample 7 is a pure chromium electrode sample (Cr), the size of the cathode sample 7 is 68*18*3 mm³, the thermal conductivity of the sample is 95 W m⁻¹ K⁻¹ and the conductivity rate is 13% IACS, the hardness is 861 HV. The rest of the structure and parameters are consistent with those in Example 6.

The cathode sample 7 is removed after the arc ablation test. After the cathode sample 7 is cooled, it is cleaned and dried, then the three-dimensional contour information of the ablation area is obtained, to get the ablation volume, which is 510±3.02 mm³. The ablation volume is divided by the ablation power to obtain the ablation loss rate, which is (47.2±0.28)×10⁻³ mm³/C.

### Example 9

The difference between this example and Example 6 is that a single wafer-shaped cathode sample 7 with a diameter of 60 mm and a thickness of 3 mm is prepared by a wire cutting method. The electrode material is pure copper with a density of 8.9 g/cm³. Of which, the arc contact surface (The top surface) is ground and polished with 500-2000 mesh sandpaper to ensure that the surface roughness Ra is ≤0.8 m, the thermal conductivity of the sample is 397 W m⁻¹ K⁻¹, the conductivity is 99% IACS, and the hardness is 75 HV.

The parameters of arc ablation test are as follows: arc current 20 A, arc ablation time 120 s, arc length 4 to 5 mm, diameter of cathode spot 0.5 to 0.8 mm, movement speed of cathode spot 10⁻² m/s.

The cathode sample 7 is removed after the arc ablation test. After the cathode sample 7 is cooled, it is cleaned and dried, then the three-dimensional contour information of the ablation area is obtained, to get the ablation volume, which is 137±1.15 mm³. The ablation volume is divided by the ablation power to obtain the ablation loss rate, which is (57.1±0.479)×10⁻³ mm³/C.

As shown in FIG. 15, it is a scanned three-dimensional contour map of corresponding wafer pure copper electrode after testing in the conditions of Example 2, of which, the green area in the center is the concave area compared to the surrounding base plane. There is red extrusion area between the ablation area and non-ablation area.

### Example 10

The difference between this example and Example 6 is that the test system uses a solenoid coil 9, which has a diameter of 150 mm and a number of turns of 20. Under 3 A DC power supply, a uniform magnetic field ranging from −120 μT to 120 μT is generated within the range of 30 mm long and 75 mm in diameter of the center of the coil, and the direction of magnetic field generated is parallel to the direction from the anode 6 to the cathode.

Cathode sample 7 is a round sheet sample with a diameter of 60 mm and a thickness of 3 mm that is prepared by wire cutting. The electrode material is pure copper and the density is 8.9 g/cm³. The arc contact surface (top surface) is ground and polished with a 500-2000 mesh sandpaper, to ensure that the surface roughness Ra is ≤0.8 m. The thermal conductivity of the sample is 395 W m⁻¹ K⁻¹, the conductivity is 99% IACS, and the hardness is 82 HV.

The arc parameters of arc ablation test include: arc current 20 A, arc ablation time 120 s, arc length 8-10 mm, cathode spot diameter 0.6-0.8 mm, movement speed of cathode spot 0.5-0.8 m/s, magnetic field intensity 75 μT.

S4. The cathode sample 7 is removed after the arc ablation test. After the cathode sample 7 is cooled, it is cleaned and dried, then the three-dimensional contour information of the ablation area is obtained, to get the ablation volume, which is 96.1±8.27 mm³. The ablation volume is divided by the ablation power to obtain the ablation loss rate, which is (40.0±3.45)×10⁻³ mm³/C.

### Example 11

The difference between this example and Example 10 is that the test system uses a solenoid coil 9, which has a diameter of 150 mm. Under 2 A DC power supply, a uniform magnetic field ranging from −80 Mt to 80 μT is generated within the range of 30 mm long and 65 mm in diameter of the center of the coil, and the direction of magnetic field generated is parallel to the direction from the anode 6 to the cathode. The rest of structure and parameters are consistent with those in Example 8.

The cathode sample 7 is removed after the arc ablation test. After the cathode sample 7 is cooled, it is cleaned and dried, then the three-dimensional contour information of the ablation area is obtained, to get the ablation volume, which is 112.7±6.12 mm³. The ablation volume is divided by the ablation power to obtain the ablation loss rate, which is (47.0±2.55)×10⁻³ mm³/C.

### Example 12

The difference between this example and Example 10 is that the cathode material used is copper-chromium alloy electrode sample (Cu50Cr50). The cathode sample 7 has a consistent size, the thermal conductivity of the sample is 239 W m⁻¹ K⁻¹, the conductivity is 61% IACS, and the hardness is 168 HV.

The rest of parameters and structures are consistent with those in the Example 10.

The cathode sample 7 is removed after the arc ablation test. After the cathode sample 7 is cooled, it is cleaned and dried, then the three-dimensional contour information of the ablation area is obtained, to get the ablation volume, which is 86.9±2.19 mm³. The ablation volume is divided by the ablation power to obtain the ablation loss rate, which is (36.2±0.91)×10⁻³ mm³/C.

### Example 13

The difference between this example and Example 10 is that the cathode material is pure chromium electrode sample (Cr). The cathode sample 7 has a consistent size, the thermal conductivity of the sample is 96 W m⁻¹ K⁻¹, the conductivity is 13% IACS, and the hardness is 862 HV.

The rest of parameters and structures are consistent with those in the Example 10.

The cathode sample 7 is removed after the arc ablation test. After the cathode sample 7 is cooled, it is cleaned and dried, then the three-dimensional contour information of the ablation area is obtained, to get the ablation volume, which is 79.8±1.02 mm³. The ablation volume is divided by the ablation power to obtain the ablation loss rate, which is (33.2±0.43)×10⁻³ mm³/C.

### Example 14

The difference between this example and Example 6 is that the test system uses a rotary drive assembly (the static torque of the motor used is 2.2 N-m, the rated current is 4 A, the seam diameter is 38 mm, and the shaft length is 25 mm). The output speed of the rotary drive assembly is 540 rpm, after conversion, the angular rotation velocity of the sample mounting part is 40 to 50 rad/s.

Cathode sample 7 is a round sheet sample with a diameter of 60 mm and a thickness of 3 mm that is prepared by wire cutting. The electrode material is pure copper and the density is 8.9 g/cm³. The arc contact surface (top surface) is ground and polished with a 500-2000 mesh sandpaper, to ensure that the surface roughness Ra is ≤0.8 m. The thermal conductivity of the sample is 393 W m⁻¹ K⁻¹, the conductivity is 99% IACS, and the hardness is 96 HV.

The arc parameters of arc ablation test include: arc current 20 A, arc ablation time 120 s, arc length 6-8 mm, cathode spot diameter 0.4-0.5 mm, movement speed of cathode spot 0.3 to 0.5 m/s.

After the arc ablation test, the ablation volume of the cathode sample 7 is 114±6.73 mm³. The ablation volume is divided by the ablation power to obtain the ablation loss rate, which is (47.5±2.80)×10⁻³ mm³/C. The ablation rate is taken as a quantitative evaluation index of ablation-resistant properties of electrode materials.

### Example 15

The difference between this example and Example 14 is that the angular rotation velocity of the rotary drive assembly is 180 rpm, and the angular rotation velocity of the sample mounting part is 10-20 rad/s after conversion.

The rest of parameters and structures are the same as those in the Example 14.

After the arc ablation test, the ablation volume of the cathode sample 7 is 124±5.62 mm³. The ablation volume is divided by the ablation power to obtain the ablation loss rate, which is (51.7±2.34)×10⁻³ mm³/C. The ablation rate is taken as a quantitative evaluation index of ablation-resistant properties of electrode materials.

### Example 16

The difference between this example and Example 14 is that the electrode material is copper-chromium alloy electrode sample (Cu50Cr50), the cathode sample 7 has a consistent size, the thermal conductivity of the sample is 236 W m⁻¹ K⁻¹, the conductivity is 60% IACS, and the hardness is 166 HV.

The rest of parameters and structures are the same as those in the Example 14.

After the arc ablation test, the ablation volume of the cathode sample 7 is 102.6±3.21 mm³.

The ablation volume is divided by the ablation power to obtain the ablation loss rate, which is (42.8±1.34)×10⁻³ mm³/C. The ablation rate is taken as a quantitative evaluation index of ablation-resistant properties of electrode materials.

### Example 17

The difference between this example and Example 14 is that the electrode material is pure chromium electrode sample (Cr), the cathode sample 7 has a consistent size, the thermal conductivity of the sample is 97 W m⁻¹ K⁻¹, the conductivity is 13% IACS, and the hardness is 860 HV.

The rest of parameters and structures are the same as those in the Example 14.

After the arc ablation test, the ablation volume of the cathode sample 7 is 93.1±4.15 mm³. The ablation volume is divided by the ablation power to obtain the ablation loss rate, which is (38.8±1.73)×10⁻³ mm³/C. The ablation rate is taken as a quantitative evaluation index of ablation-resistant properties of electrode materials.

TABLE 1
Ablation performance of electrode samples

| | | | | Char- | | | | | |
|---|---|---|---|---|---|---|---|---|---|
| | | | | acter- | | | | Ablation | |
| | | Arcing | Arcing | istic | | | Ablation | loss rate | Ablation- |
| | Ablation | current | time | Para- | | Sample | volume | *10⁻³ | resistant |
| Case | scheme | (A) | (s) | meter | Component | size | (mm³) | (mm³/C) | properties |
| 6 | Stagnation | 15 | 720 | — | Cu | 68*18*3 | 672 ± 2.57 | 62.2 ± 0.238 | Poor |
| | point | | | | | mm³ | | | |
| | ablation | | | | | | | | |
| 7 | Stagnation | 15 | 720 | — | Cu50Cr50 | 68*18*3 | 526 ± 6.21 | 48.7 ± 0.575 | Ordinary |
| | point | | | | | mm³ | | | |
| | ablation | | | | | | | | |
| 8 | Stagnation | 15 | 720 | — | Cr | 68*18*3 | 510 ± 3.02 | 47.2 ± 0.28 | Ordinary |
| | point | | | | | mm³ | | | |
| | ablation | | | | | | | | |
| 9 | Stagnation | 20 | 120 | — | Cu | ϕ60*3 | 137 ± 1.15 | 57.1 ± 0.479 | Poor |
| | point | | | | | mm² | | | |
| | ablation | | | | | | | | |
| 10 | Magnetic | 20 | 120 | Combi- | Cu | ϕ60*3 | 96.1 ± 8.27 | 40.0 ± 3.45 | Ordinary |
| | drive | | | nation | | mm² | | | |
| | rotating | | | 1 | | | | | |
| | arc | | | | | | | | |
| | root | | | | | | | | |
| 11 | Magnetic | 20 | 120 | Combi- | Cu | ϕ60*3 | 112.7 ± 6.12 | 47.0 ± 2.55 | Ordinary |
| | drive | | | nation | | mm² | | | |
| | rotating | | | 2 | | | | | |
| | arc | | | | | | | | |
| | root | | | | | | | | |
| 12 | Magnetic | 20 | 120 | Combi- | Cu50Cr50 | ϕ60*3 | 86.9 ± 2.19 | 36.2 ± 0.91 | Excellent |
| | drive | | | nation | | mm² | | | |
| | rotating | | | 1 | | | | | |
| | arc | | | | | | | | |
| | root | | | | | | | | |
| 13 | Magnetic | 20 | 120 | Combi- | Cr | ϕ60*3 | 79.8 ± 1.02 | 33.2 ± 0.43 | Excellent |
| | drive | | | nation | | mm² | | | |
| | rotating | | | 1 | | | | | |
| | arc | | | | | | | | |
| | root | | | | | | | | |
| 14 | Motor | 20 | 120 | Combi- | Cu | ϕ60*3 | 114 ± 6.73 | 47.5 ± 2.80 | Ordinary |
| | drive | | | nation | | mm² | | | |
| | arc root | | | 3 | | | | | |
| 15 | Motor | 20 | 120 | Combi- | Cu | ϕ60*3 | 124 ± 5.62 | 51.7 ± 2.34 | Poor |
| | drive | | | nation | | mm² | | | |
| | arc root | | | 4 | | | | | |
| 16 | Motor | 20 | 120 | Combi- | Cu50Cr50 | ϕ60*3 | 102.6 ± 3.21 | 42.8 ± 1.34 | Ordinary |
| | drive | | | nation | | mm² | | | |
| | arc root | | | 3 | | | | | |
| 17 | Motor | 20 | 120 | Combi- | Cr | ϕ60*3 | 93.1 ± 4.15 | 38.8 ± 1.73 | Ordinary |
| | drive | | | nation | | mm² | | | |
| | arc root | | | 3 | | | | | |

### Description of Characteristic Parameters in Above FIG. 1.

1. Combination 1: The coil generates a magnetic field drive, the power supply current is 3 A, the central magnetic field intensity is −120 μT to 120 μT, and the cathode spot moving speed is 0.5 to 0.8 m/s;
2. Combination 2: The coil generates a magnetic field drive, the power supply current is 2 A, the central magnetic field intensity is −80 μT to 80 μT, and the cathode spot moving speed is 0.2 to 0.4 m/s;
3. Combination 3: Electrode drive, output speed is 540 rpm, the angular rotation speed of the sample mounting part is 40 to 50 rad/s;
4. Combination 4: Electrode drive, output speed is 180 rpm, the angular rotation speed of the sample mounting part is 10 to 20 rad/s.

### Ablation Resistance Analysis:

1. The intra-group comparisons of Examples 6, 7, 8, Examples 10, 12, 13 and Examples 14, 16, 17 show that the pure chromium has the most excellent ablation resistance, followed by copper and chromium, and pure copper is the worst;
2. Compared with example 9, magnetic field coil used in Example 10 can effectively improve the ablation resistance of the electrode;
3. Compared with Example 10, the magnetic field coil used in Example 11 can improve the magnetic field intensity to increase the arc root speed, and reduce electrode ablation;
4. Compared with Example 9, the motor-driven sample rotation used in Example 14 can improve the ablation resistance of the electrode;
5. Compared with Example 15, the motor-driven sample rotation used in Example 14 can increase the motor speed and reduce electrode ablation.

### Example 16

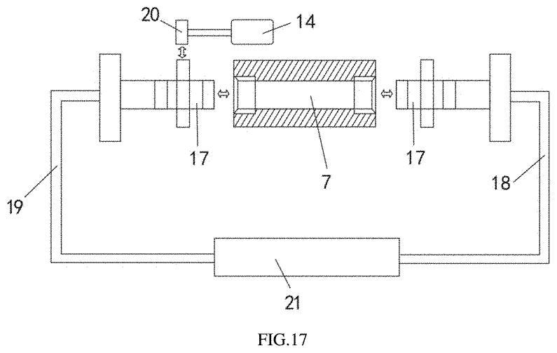

As shown in FIG. 16 and FIG. 17, it is a test system and a driving device in which the cathode is a tubular sample and the arc and the flat sheet cathode sample 7 are relatively displace when performing testing on the arc ablation resistance of materials.

As shown in FIG. 17, the cathode sample 7 is a hollow tube with openings at both ends of the cathode, both ends of the cathode sample 7 are connected to a high-pressure rotary joint 17 in a sealed manner respectively, one high-pressure rotary joint 17 is connected to the coolant input tube and the other high-pressure rotary joint is connected to the coolant output tube 18, the coolant enters the hollow tube from the input tube 19 and flows out from the output tube 18, a cooling mechanism for cooling the coolant is arranged between the input tube 19 and the output tube 18, or a liquid storage device 21 for providing coolant is arranged between the input tube 19 and the output tube 18; the cathode sample 7 is connected with the driving device, and the anode 6 is aligned with the outer surface of the cathode sample 7. The arc is formed between the anode 6 and the cathode, the cathode sample 7 rotates around the central axis, and the root of the arc is displaced along the outer surface of the cathode.

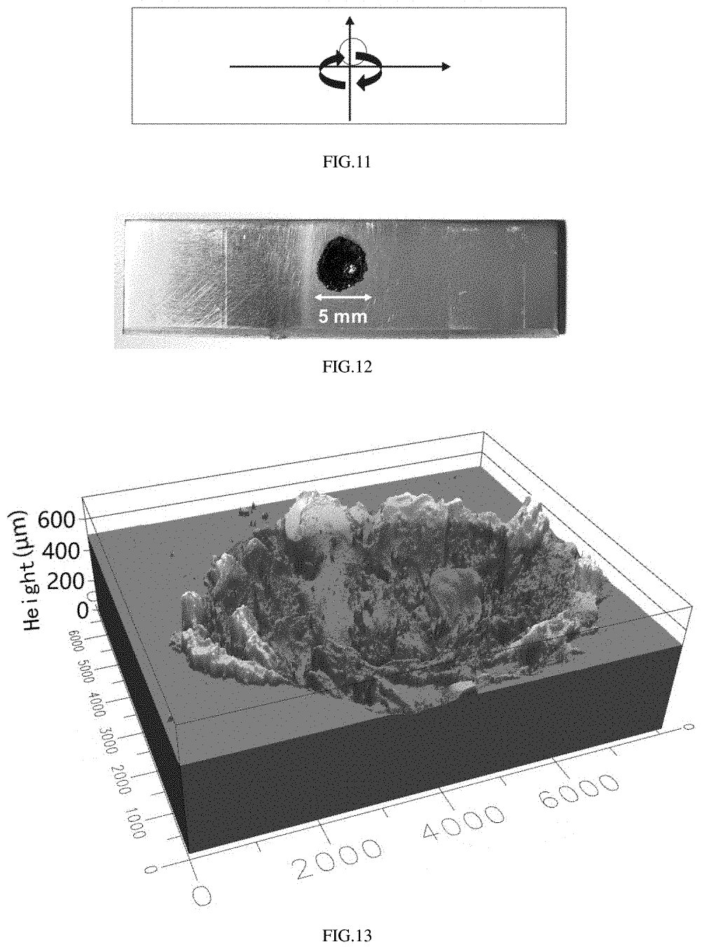

The anode 6 is fixed, or the anode 6 is connected to a translation drive mechanism that provides translation along the axial direction of the hollow tube. When the anode 6 is translated along the axial direction of the hollow tube, the arc root forms a spiral line along the outer surface of the cathode, as shown in FIG. 11. When the anode 6 is fixed, the arc root forms a circle along the outer surface of the cathode.

The high-pressure rotary joint 17 comprises a first connecting portion connected to the cathode sample 7, a second connecting portion connected to the tube, the first connecting portion and the second connecting portion are rotatably sealed and connected; the first connecting portion is connected with the driving device, and the second connecting portion is fixed on a bracket; and cathode sample 7 is erected on the bracket by two high-voltage rotary joints.

The driving device comprises a motor 14 and a transmission mechanism 20. The transmission mechanism 20 is a gear mechanism, or a turbine screw, or a chain transmission mechanism 20, etc.

The translation drive mechanism includes three high-precision linear slide rails respectively driven by independent motors, and uniformly controlled by the control center, which can realize the positioning before the ablation test, the trajectory control during the experiment, and the return to the original position at the end of the experiment, etc. The positioning accuracy of the linear slide rail is 0.5 mm.

By adopting the above technical solution, the present invention can achieve the following effects: firstly, a variety of arc ablation tests in a three-dimensional space can simulate the complex arc-electrode interaction process in the heater; secondly, with the positioning of the arc output end in the Z-axis direction, the ablation effect of arc with the variable arc length on the material is realized; thirdly, with the rapid positioning and returning to the origin of the three-axis motion slide rail, the rapid start and high repeatability of the test system are realized; fourthly, the use of sheet samples simplifies the original blank processing process, with quick assembly, and good test repeatability; fifthly, the high-precision shunt completes the real-time acquisition of the current and voltage parameters of the arc; and sixthly, the real-time monitoring system ensures that the shape of the arc can be recorded.

The content described in the embodiments of this specification is merely an enumeration of the realization forms of the inventive concept. The scope of protection of the present invention should not be regarded as limitation to the specific forms described in the embodiments. The protection scope of the present invention also extends to equivalent technical means that can be thought by those skill in the art based on the concept of the present invention.

What is claimed is:

1. A method for quantitatively evaluating ablation-resistant properties of materials, comprising following steps:
S1. building or acquiring a test system;
S2. preparing a cathode sample and setting a minimum ablation time;
S3. loading the cathode sample into the test system, and conducting an arc ablation test on the cathode sample, and recording arc ablation parameters when the ablation time of the test is greater than or equal to the minimum ablation time; and,
S4. removing the cathode sample after the arc ablation test, and after cooling, performing cleaning and drying of the cathode sample, then acquiring three-dimensional contour information of an ablation area, obtaining an ablation volume, and dividing the ablation volume by an ablation power to obtain an ablation loss rate, and taking the ablation loss rate as a quantitative evaluation index of ablation-resistant properties of electrode materials.

2. The method for quantitatively evaluating ablation-resistant properties of materials according to claim 1, wherein the three-dimensional contour information of the ablation area is acquired by a surface profiler in step S4.

3. The method for quantitatively evaluating ablation-resistant properties of materials according to claim 1, wherein an arc contact surface of the cathode sample is smooth and free of local protrusions, and a surface roughness Ra of the arc contact surface is less than or equal to 0.8 μm in step S2.

4. The method for quantitatively evaluating ablation-resistant properties of materials according to claim 1, wherein a sample arc contact surface is subjected to grinding, polishing and drying in step S2.

5. The method for quantitatively evaluating ablation-resistant properties of materials according to claim 1, wherein the testing on a thermal conductivity, electrical conductivity and hardness of the sample is performed at a room temperature after processing the arc contact surface of the cathode sample in step S2.

6. The method for quantitatively evaluating ablation-resistant properties of materials according to claim 1, wherein the arc contact surface of the cathode sample is maintained horizontally in a vertical direction when loading sample in step S3, and an anode electrode is moved synchronously to align the ablation starting position of the cathode sample.

7. The method for quantitatively evaluating ablation-resistant properties of materials according to claim 1, where the cathode sample is ultrasonically cleaned in step S2, and the ablated cathode sample is ultrasonically cleaned in step S4.

8. A test system used in the method for quantitatively evaluating ablation-resistant properties of materials of claim 1, comprising an anode, a sample mounting part for loading the cathode sample, a cooling system for cooling the cathode sample, and a protective cover; an arc is generated between the cathode and the anode, and is located in the protective cover; the anode and the cathode are provided with ports connected with an arcing power supply respectively; there is a relative movement between the cathode sample and the arc.

9. The test system according to claim 8, wherein the cathode sample is a sheet sample, and the sample mounting part carries the cathode sample to rotate around a center, and the arc is fixed or moves in a radial direction; the sample mounting part comprises a base, the base has a cooling medium chamber and a liquid inlet ring, the cooling medium chamber is located in the sample loading area, when the cathode sample is loaded on the sample mounting part, the cathode sample is centered with the sample loading area; the cooling medium chamber is inside and the liquid inlet ring is outside, and the liquid inlet ring is in communication with the cooling medium chamber and is in rotatably sealing fit; the liquid inlet ring is fixed and connected with a liquid inlet tube, the center of the cooling medium chamber is provided with a liquid outlet channel; the test system has a rotary drive assembly connection, and the rotary drive assembly includes a driven wheel fixed to the base and a driving wheel connected with a motor, and the driven wheel is centered with the base.

10. The test system according to claim 9, wherein the base is cylindrical, a side wall of the cooling medium chamber is provided with a plurality of through holes, the liquid inlet ring is in a form of a circular ring, and the liquid inlet ring covers all the through holes, and a sealing ring is arranged between the liquid inlet ring and the base.

11. The test system of claim 10, wherein the base and the driven wheel are coaxially fixed, the base is inside, and the driven wheel is outside; and/or the base is an integrated cylinder, and the top of the cylinder is open and is in sealing fit with the cathode sample, the bottom of the cylinder is provided with a liquid outlet channel.

12. The test system according to claim 11, wherein the base comprises a cathode base top cover and a fixed base, the middle of the cathode base top cover is provided with a through hole, the cathode base top cover and the fixed base are in rotatably sealing fit, the cathode base top cover and the fixed base are combined to form a cooling medium chamber; the cathode base top cover and the fixed base are in rotatable fit, and a sealing ring is arranged between the cathode base top cover and the fixed base.

13. The test system according to claim 12, wherein the cathode base top cover has a first connecting portion connected with the cathode sample and a second connecting portion connected with the driven wheel; the first connecting portion has a distance from the driven wheel; and/or the first connecting portion and the second connecting portion are in a two-segment form, the second connecting portion extends a ring of flange outwards along the first connecting portion, and the second connecting portion serves as a flange connected to the driven wheel, by this way, a stable connection between the cathode base top cover and the driven wheel is realized.

14. The test system according to claim 8, wherein the cathode sample is a sheet sample, and the cathode sample is detachably assembled with the sample mounting part; the cathode sample is fixed, and the arc rotates around the center of the cathode sample; an electromagnetic coil is provided outside the protective cover, and a magnetic field direction of the electromagnetic coil is parallel to the direction where the anode points to the cathode, an electromagnetic coil has a port connected to a coil power supply; an insulating ring is provided outside the sample loading area, and the insulating ring is centered with the sample loading area.

15. The test system according to claim 14, wherein the sample mounting part comprises a base, the base is provided with a cooling medium chamber, the cooling medium chamber is respectively in communication with a liquid inlet tube and a liquid outlet tube, and the liquid inlet tube and the liquid outlet tube are connected with a circulating cooling system; when the cathode sample is loaded on the sample mounting part, the cathode sample closes the cooling medium chamber; the cooling medium chamber is an open concave chamber at the top of the base, when the sample is loaded on the sample mounting part, the cathode sample closes the cooling medium chamber; the liquid inlet tube and the liquid outlet tube are arranged on the side of the base; the liquid inlet tube is lower than the liquid outlet tube.

16. The test system according to claim 8, wherein gas inflows from an atmosphere inlet of the protective cover axially and/or tangentially.

17. The test system according to claim 16, wherein a cross-section of the protective cover is circular, the protective cover is provided with an atmosphere inlet, and gas inflows from the atmosphere inlet tangentially, and/or there are at least one group of atmosphere inlets and when there are multiple groups of atmosphere inlets, the multiple groups of atmosphere inlets are uniformly arranged along a circumferential direction of the contour.

18. The test system according to claim 8, wherein the cathode sample is a hollow tube with openings at both ends of the cathode, both ends of the cathode sample are connected to a high-pressure rotary joint in a sealed manner respectively, one high-pressure rotary joint is connected to a coolant input tube and an other high-pressure rotary joint is connected to a coolant output tube, the coolant enters the hollow tube from the input tube and flows out from the output tube, a cooling mechanism for cooling the coolant is arranged between the input tube and the output tube, or a liquid storage device for providing coolant is arranged between the input tube and the output tube; the cathode sample is connected with a driving device, and the anode is aligned with an outer surface of the cathode sample, the arc is formed between the anode and the cathode, the cathode sample rotates around a central axis, and the root of the arc is displaced along the outer surface of the cathode.

19. The test system according to claim 18, wherein the anode is fixed, or the anode is connected to a translation drive mechanism that provides translation along an axial direction of the hollow tube, when the anode is translated along the axial direction of the hollow tube, the arc root forms a spiral line along the outer surface of the cathode, when the anode is fixed, the arc root forms a circle along the outer surface of the cathode.

20. The test system according to claim 19, wherein the high-pressure rotary joint comprises a first connecting portion connected to the cathode sample, a second connecting portion connected to the tube, the first connecting portion and the second connecting portion are rotatably sealed and connected; the first connecting portion is connected with the driving device, and the second connecting portion is fixed on a bracket; and cathode sample is erected on the bracket by two high-voltage rotary joints.
